(19) United States
(12) Patent Application Publication
(10) Pub. No.: US 2005/0253036 A1
(43) Pub. Date: Nov. 17, 2005

(54) Horizontal drive apparatus for use with a vehicle seat slide

(75) Inventors: Feng Li, Troy, MI (US); David Jean-Henri Treves, Troy, MI (US); John M. Perraut, Rochester Hills, MI (US)

Correspondence Address: HOFBAUER ASSOCIATES, SUITE 205 NORTH, 1455 LAKESHORE ROAD, BURLINGTON, ON, L7S 2J1, CA

(73) Assignee: Faurecia Automotive Seating Canada Limited, Mississauga (CA)

(21) Appl. No.: 11/114,154

(22) Filed: Apr. 26, 2005

Related U.S. Application Data
(60) Provisional application No. 60/570,441, filed on May 13, 2004.

(51) Int. Cl. F16M 13/00

(52) U.S. Cl. 248/424

(57) ABSTRACT

A horizontal drive apparatus for use with a vehicle seat slide having mating fixed and movable track members which are movable between forward and rearward configurations. The horizontal drive apparatus includes an elongate spindle, a spindle nut, a transmission, and a mounting apparatus. The spindle defines a spindle axis, and has a longitudinally extending spindle thread. The spindle nut is securely mountable to a first track member, and has an internal thread that is engagable with the spindle thread. The transmission is mountable to a respective other track member, and selectively rotates the spindle about the spindle axis. The mounting apparatus is interposable between the transmission and the other track member in securable relation to each. The mounting apparatus includes a damping apparatus for attenuating noise and vibration emanating from the transmission during use.

### FIELD OF THE INVENTION

The present invention relates to adjustable seat slide mechanisms for use in vehicles, and more particularly, to horizontal drive mechanisms for use with such seat slide mechanisms.

### BACKGROUND OF THE INVENTION

Vehicle seats are commonly provided with seat slide mechanisms to facilitate their adjustment in a horizontal direction between forward and rearward configurations. Typically, such vehicle seat slides include a stationary seat track member affixed to the vehicle floor and a movable seat track member which is operatively intersliding with the stationary seat track member and fixed to a seat cushion member of a vehicle seat, so as to permit controlled horizontal movement of the movable seat track member relative to the stationary seat track member, and thereby to provide for horizontal (i.e. fore-aft) adjustment of the vehicle seat for the comfort and safety of a seat occupant. Seat slide mechanisms of this general form are disclosed in, for example, U.S. Pat. No. 5,692,839 (issued Dec. 2, 1997 to Rohee et al., entitled Vehicle Seat Slide) and U.S. Pat. No. 6,845,956 (issued Jan. 25, 2005 to Rohee, entitled Track Assembly For A Motor Vehicle Seat, And A Seat Equipped With Such A Track Assembly), the teachings of which patents are hereby incorporated by reference. Moreover, a seat slide of this general type is available from Faurecia Sieges d'automobile S.A., of Paris, France, under its Model No. 4CB.

It is also well known, in the prior art, to provide horizontal drive mechanisms for use with such vehicle seat slide mechanisms. Such horizontal drive mechanisms typically include an elongate spindle or lead screw assembly mounted to a first one of the track members, and a spindle nut threadingly engaging the spindle and mounted to the other one of the track members. A transmission housing typically encloses a selectively driven worm screw that threadingly engages a toothed worm wheel formed on an outer surface of the lead screw to rotate same about a longitudinal axis thereof. When a user selectively actuates such a prior art horizontal drive mechanism, the lead screw is rotated about its longitudinal axis and the spindle nut is moved therealong, such that the seat cushion is then moved between the forward and the rearward configurations. A horizontal drive mechanism of this general form is disclosed in, for example, U.S. Pat. No. 5,342,013 (issued Aug. 30, 1994 to Ito et al., entitled Seat Sliding Device For Vehicle), the teachings of which patent are hereby incorporated by reference.

Horizontal drive mechanisms in the prior art have heretofore been rigidly mounted to the vehicle seat slide. For this purpose, and by way of example, horizontal drive mechanisms have been provided with a transmission housing that is rigidly fastened to a track member of the vehicle seat slide by way of metal fasteners (such as rivets or dowel pins) which extend from, or pass through, the transmission housing for mating fitment within corresponding apertures formed in the track member. During fore-aft adjustment of the vehicle seat, in electrically powered applications of the general type described, the driven worm screw may spin at speeds as high as 3,000 rotations per minute. Due in no small part to such rigid connection, such prior art horizontal drive mechanisms have been known to generate, propagate, and transmit a great deal of vibration and noise to both the vehicle seat slide and the surrounding environment. It is unpleasant, undesirable, and generally unacceptable in today's vehicle market for any such vibration or noise to be perceived by an occupant of the vehicle or seat assembly. Further, prolonged or recurring exposure to vibration can cause loosening and degradation of the component elements of the horizontal drive mechanism, vehicle seat slide, and seat assembly. Thus, a significant problem associated with prior art horizontal drive mechanisms (particularly those of the power drive type) has been the generation, propagation and transmission of noise and vibration to the vehicle seat slide and the surrounding environment during fore-aft adjustment of the seat assembly.

Additionally, the prior art mounting of horizontal displacement mechanisms by the use of pins or other fasteners that fit within mating apertures in the vehicle seat slide is subject to a number of further problems, especially insofar as part machining tolerances and efficiency of manufacture and assembly are concerned. That is, such mounting pins and their mating apertures have heretofore been required to be precisely mass manufactured within very close tolerances of one another so as to ensure as close a fit as possible. This adds to the complexity of the mechanism and its cost of manufacture. Likewise, it has heretofore been unduly cumbersome and inefficient to mount a prior art horizontal drive mechanism of the type described above to a vehicle seat slide—a problem which has also led to increased costs being incurred during the assembly of such seat components.

None of the current designs of horizontal drive mechanisms are adapted to be mounted to vehicle seat slides in a manner that obviates the aforesaid problems.

What is needed, therefore, is a horizontal drive mechanism that may be quickly and easily mounted to a vehicle seat slide without the use dowel pins and the like and so as to attenuate noise and vibration emanating from the transmission housing of the device during use. Preferably, such a horizontal drive mechanism includes a resilient mounting member that is adapted to interposably engage, in compressible secured relation, the transmission housing of the horizontal drive mechanism and one of the track members of the vehicle seat slide, so as to suppress noise and vibration generated within the transmission housing from passing into the track member and beyond. Ideally, such a mounting member should also restrain longitudinal sliding movement of the transmission housing relative to the track member to which it is mounted, both in ordinary use and during a crash event.

It is, therefore, an object of the present invention to provide a horizontal drive apparatus that attenuates noise and vibration emanating from the transmission housing during use.

It is another object of the invention to provide a horizontal drive apparatus that includes a mounting means that is adapted to secure a transmission housing to one of the track members of the vehicle seat slide, with the mounting means securely interposed therebetween in noise and vibration damped relation.

It is a further object of the invention to provide a horizontal drive apparatus that is adapted to engage, in compressible secured relation, at least one of the transmission housing and a track member of the vehicle seat slide, such that the transmission housing is removed from direct contacting relation with the track member.

It is still another object of the invention to provide a horizontal drive apparatus that includes a mounting means that is adapted to overlie and engage an outer surface of the transmission housing in compressible secured surrounding relation.

It is a still further object of the invention to provide a horizontal drive apparatus that includes a mounting means that is adapted to underlie and engage an inner track surface of the track member in compressible secured relation.

It is yet another object of the invention to provide a horizontal drive apparatus that includes a mounting means that is adapted to deformingly engage the track member in a crash event and to provide increased resistance to dissociation of the transmission housing from the track member during such an event.

It is a yet further object of the invention to provide a horizontal drive apparatus that may be quickly and efficiently mounted to the vehicle seat slide during assembly.

It is still yet another object of the invention to provide a horizontal drive apparatus that may be quickly and easily aligned and attached to with a track member of the vehicle seat slide during assembly, and that obviates the need for dowel pins and similar prior art fastening means and thereby reduces the need for fine tolerancing associated with such prior art fastening means.

### SUMMARY OF THE INVENTION

In accordance with the present invention there is disclosed a horizontal drive apparatus for use with a vehicle seat slide defining a longitudinal axis. The vehicle seat slide has mating fixed and movable track members, with the movable track member slidably engaging the mating fixed track member for movement of the vehicle seat slide along the longitudinal axis between a forward configuration and a rearward configuration. The fixed and movable track members are securely mountable to a vehicle cabin floor and to a vehicle seat cushion member respectively. The horizontal drive apparatus includes an elongate spindle that defines a spindle axis substantially parallel to the longitudinal axis. The spindle has a longitudinally extending spindle thread portion. The horizontal drive apparatus also includes a spindle nut that is securely mountable to a first one of the track members. The spindle nut has an internal thread portion that is threadingly engagable with the spindle thread portion. The horizontal drive apparatus also includes a transmission means, mountable to a respective other one of the track members, for selectively rotating the spindle about the spindle axis. The horizontal drive apparatus also includes a mounting means for securing the transmission means to the other one of the track members with the mounting means securely interposed therebetween. The mounting means includes a damping means for attenuating noise and vibration emanating from the transmission means during use.

According to another aspect of the invention, the damping means includes at least one resilient member adapted to engage, in compressible secured relation, at least one of the transmission means and the other one of the track members, such that the transmission means is removed from contacting relation with the other one of the track members.

According to a further aspect of the invention, the transmission means includes a transmission housing. The resilient member is adapted to engage at least one outer housing surface of the transmission housing in the compressible secured relation.

According to still another aspect of the invention, the resilient member includes a rubberized jacket having an inner jacket surface. The inner jacket surface is adapted to overlie and engage the outer housing surface in compressible secured surrounding relation.

According to a still further aspect of the invention, the mounting means also includes a retention clip member that has a transmission retaining portion. The transmission retaining portion is adapted to secure the inner jacket surface to the outer housing surface in the compressible secured surrounding relation without itself contacting the outer housing surface.

According to yet another aspect of the invention, the retention clip member has a track retaining portion. The track retaining portion is securely engagable with the other one of the track members to substantially restrain longitudinal sliding movement of the other one of the track members relative to the retention clip member and to the transmission housing.

According to a yet further aspect of the invention, the transmission retaining portion is a spring clip having terminal lug portions which are adapted to secure the inner jacket surface to the outer housing surface in the aforesaid compressible secured relation.

According to still yet another aspect of the invention, the jacket has an outer jacket surface that is adapted to underlie and engage at least one inner track surface of the other one of the track members in the aforesaid compressible secured relation.

According to a still yet further aspect of the invention, the spring clip is formed as a “U”-shaped saddle member having opposed arms and a connecting cross-member. Each of the terminal lug portions extends in a substantially inward direction from a respective one of the arms.

According to yet still another aspect of the invention, the outer housing surface is shaped to define two shoulders. Each of the terminal lug portions includes a catch member that is adapted to secure the inner jacket surface to a respective one of the shoulders in the aforesaid compressible secured relation.

According to another aspect of the invention, the track retaining portion of the retention clip member includes at least one ear member extending from the spring clip in a substantially outward direction. Each ear member is extendable at least partially through a track ear aperture that is defined by the other one of the track members, so as to restrainingly engage the other one of the track members.

According to still another aspect of the invention, the at least one ear member includes two ear members that are adapted to extend one each in the outward direction from a respective one of the arms. Each of the ear members is fully extendable through a respective one track ear aperture.

According to a still further aspect of the invention, the outer housing surface is shaped to define a substantially continuous peripheral channel that is substantially adjacent to each shoulder. The inner jacket surface defines a substantially inwardly directed corresponding waist portion. The arms and the cross-member of the saddle member are substantially integrated within the waist portion of the inner jacket surface. The waist portion is adapted to be received within the channel in close interfitting relation with the saddle member substantially straddling the outer housing surface, thereby to substantially restrain longitudinal sliding movement of the retention clip member relative to the transmission housing.

According to a yet further aspect of the invention, at least a first one of the ear members and the track ear aperture is shaped to define at least one tooth member. Each tooth member is adapted to deformingly engage a respective other one of the ear members and the track ear aperture in a crash event.

According to still yet another aspect of the invention, the aforesaid at least one tooth member includes a plurality of teeth members. Each track ear aperture is shaped to define the teeth members. Each of the teeth members is adapted to deformingly engage a respective one of the ear members in a crash event.

According to a still yet further aspect of the invention, the track retaining portion of the retention clip member further includes at least one track retaining lug member that extends in the outward direction from the spring clip. Each track retaining lug member is extendable at least partially through a track lug aperture that is defined by the other one of the track members. Each track retaining lug member is adapted to deformingly engage the track lug aperture in a crash event.

According to a yet still further aspect of the invention, the aforesaid at least one track retaining lug member includes two track retaining lug members that extend in the outward direction from the cross-member.

In accordance with another aspect of the present invention there is disclosed a mounting apparatus for use with a vehicle seat slide track member and a transmission housing. The mounting apparatus includes a resilient member that is adapted to interposably engage, in compressible secured relation, the transmission housing and the track member, such that the transmission housing is removed from contacting relation with the track member, and so as to attenuate noise and vibration emanating from the transmission housing during use.

It is thus an object of this invention to obviate or mitigate at least one of the above mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the horizontal drive apparatus according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a front top left perspective view of a vehicle seat assembly mounted on two parallel seat slides, with each seat slide incorporating a horizontal drive apparatus according to the present invention;

FIG. 2 is a rear top right perspective view of a single seat slide and horizontal drive apparatus of FIG. 1;

FIG. 3 is a rear top right perspective view on an enlarged scale of encircled area 3 of FIG. 2;

FIG. 4 is a rear top right perspective view similar to FIG. 3, shown without the seat slide;

FIG. 5 is a rear top right perspective exploded view of the horizontal drive apparatus of FIG. 4;

FIG. 6 is a top plan view of the horizontal drive apparatus of FIG. 4;

FIG. 7 is a bottom plan view of the horizontal drive apparatus of FIG. 4;

FIG. 8 is a left side elevational view of the horizontal drive apparatus of FIG. 4, shown with the seat slide in an assembly configuration;

FIG. 9 is a left side elevational view of the horizontal drive apparatus of FIG. 3, shown with the vehicle seat slide in phantom outline;

FIG. 10 is a sectional view along sight line 10-10 of FIG. 9;

FIG. 11 is a rear elevational view of a component of the horizontal drive apparatus shown in FIG. 5;

FIG. 12 is a sectional view along sight line 12-12 of FIG. 11;

FIG. 13 is a bottom plan view of the component illustrated in FIG. 11; and

FIG. 14 is a sectional view along sight line 14-14 of FIG. 9.

### DETAILED DESCRIPTION OF A PREFERRED EMBODIMENT

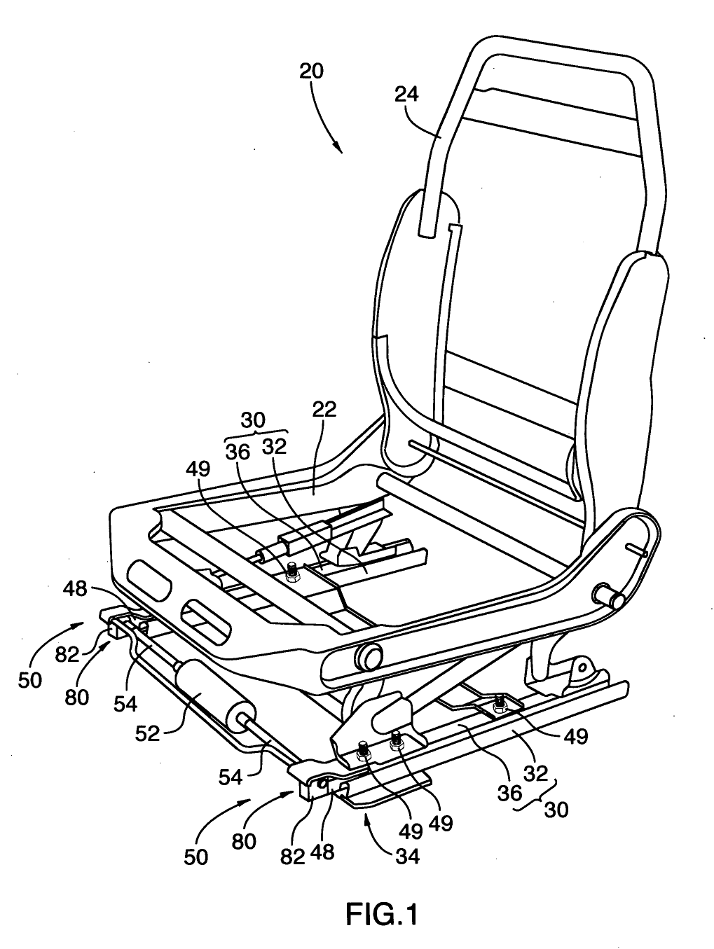

Referring now to FIG. 1 of the drawings, there is shown a vehicle seat assembly 20 mounted on two substantially parallel vehicle seats slides 30, 30. The vehicle seat assembly 20 is of the general type that includes a seat cushion member 22 and a seatback portion 24 foldable over the seat cushion member 22 in a known manner. Conventional upholstery materials are provided on each of the seatback portion 24 and the seat cushion member 22 to support a user (not shown). As shown in FIG. 1, and according to a preferred embodiment of the present invention, each of the seat slides 30, 30 has a horizontal drive apparatus 50, 50 respectively mounted thereto.

The seat slides 30, 30 and the respectively associated horizontal drive apparatuses 50, 50 of the present invention, are essentially identical mirror images of one another, and for the sake of brevity, only the left-side seat slide 30 of FIG. 1 and its corresponding horizontal drive apparatus 50 will be hereinafter described in detail.

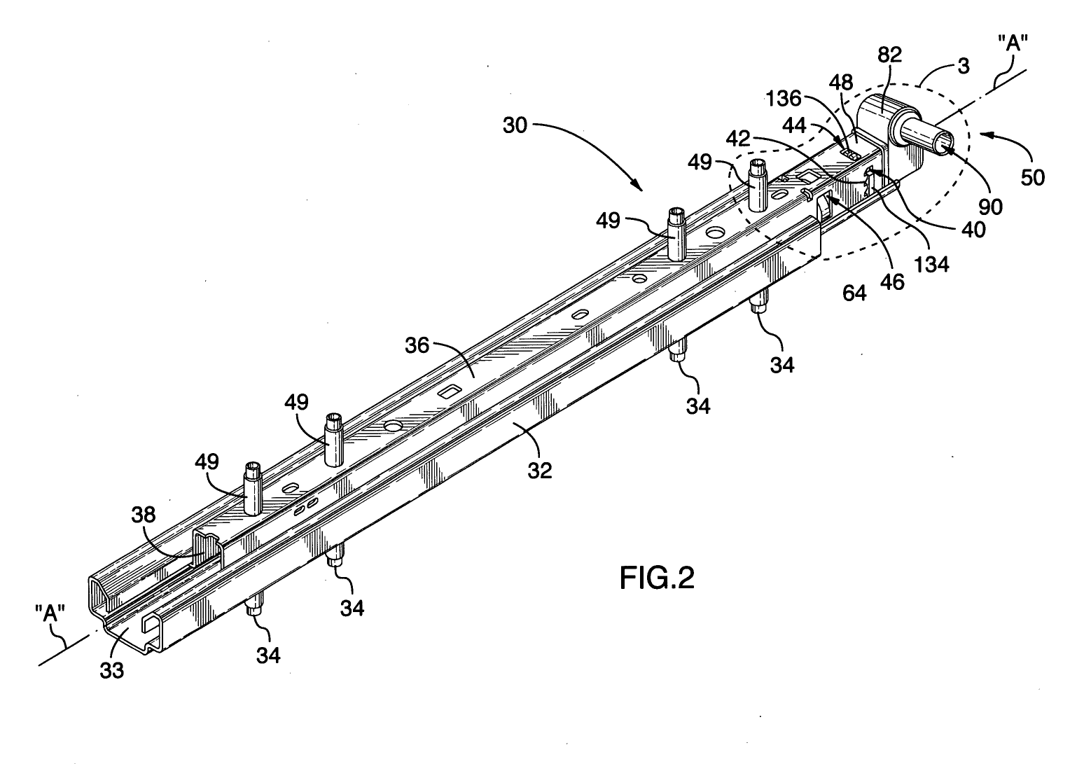

As best seen in FIG. 2, each seat slide 30 defines a substantially horizontal longitudinal axis “A”, and has mating fixed and movable track members, 32 and 36 respectively. The movable track member 36 slidably engages its mating fixed track member 32 for movement of the vehicle seat slide 30 along the longitudinal axis “A” between a forward configuration (best seen in FIGS. 2 and 9) and a rearward configuration (best seen in FIG. 1). As shown in FIGS. 1 and 2, each fixed track member 32 is provided with conventional floor fasteners 34 to securely mount it to a vehicle cabin floor (not shown) in known manner. The movable track member 36 is provided with conventional seat cushion fasteners 49 to securely mount it to the seat cushion member 22 in a known manner.

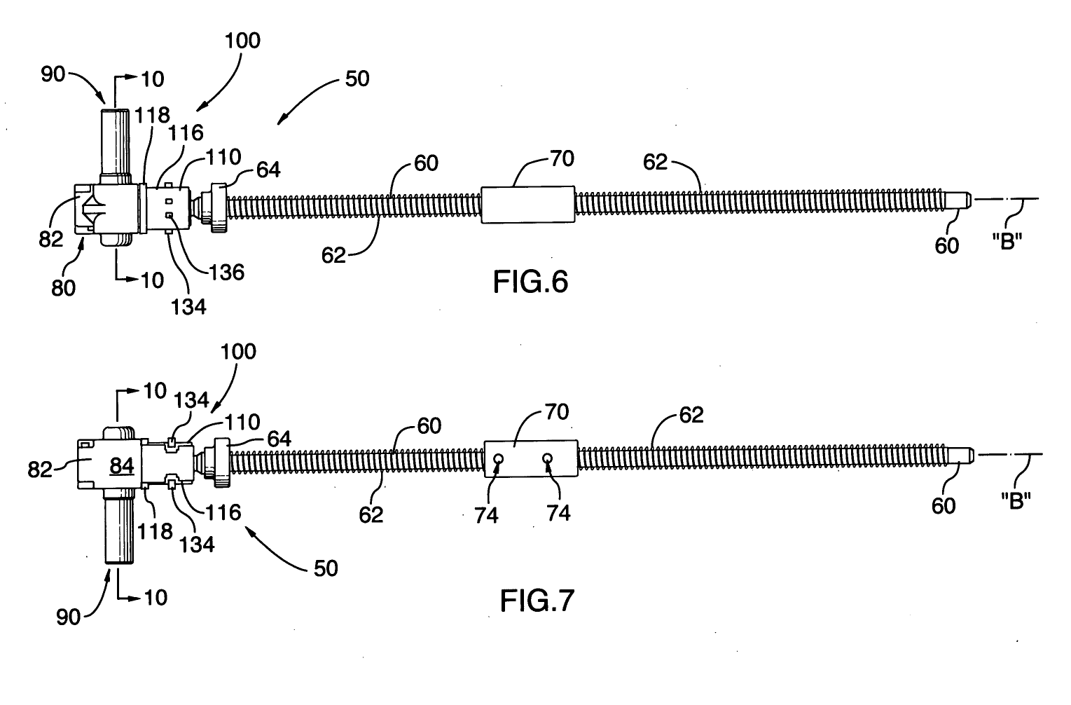

As best seen in FIGS. 6, 7 and 9, each horizontal drive apparatus 50 includes an elongate spindle 60 and a spindle nut 70. The spindle 60 is rotatable about a spindle axis “B” thereof. The spindle 60 has a longitudinally extending spindle thread portion 62. The spindle nut 70 has an internal thread portion (not shown) threadingly engages the spindle thread portion 62 of the spindle 60, such that rotation of the spindle 60 about its spindle axis “B” translates the spindle nut 70 along the spindle thread portion 62 thereof.

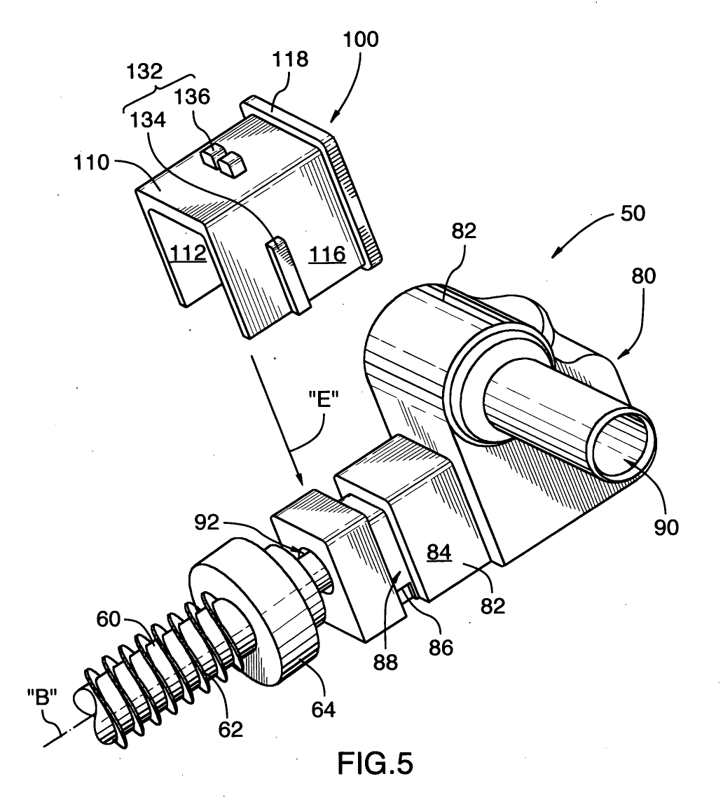

As shown in FIG. 1, each horizontal drive apparatus 50 preferably includes a transmission means 80 for selectively rotating the spindle 60 about the spindle axis “B”. Each transmission means 80 has a gear box or transmission housing 82. As best seen in FIG. 5, each transmission housing 80 has an outer housing surface 84 defining a drive aperture 90 and a spindle aperture 92 extending therethrough.

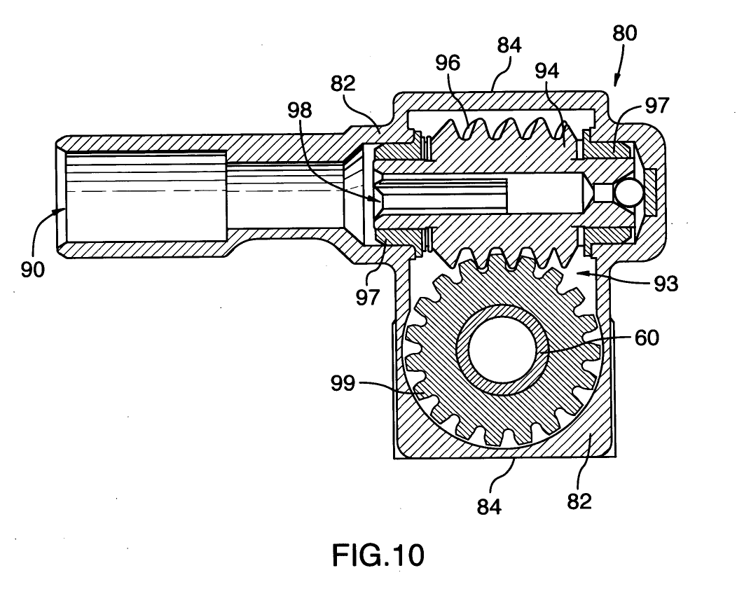

As shown in FIG. 10, each transmission housing 82 defines an inner housing chamber 93 that substantially encloses a selectively rotatable pinion member 94 and a toothed worm wheel 99. The pinion member 94 defines a hex nut sleeve coupling 98, and is rotatably mounted in the inner housing chamber 93 in supported relation by two pinion bearings 97. The pinion member 94 has a worm screw thread 96 that is in rotatable driving meshed engagement with the toothed worm wheel 99. The toothed worm wheel 99 securely engages, in substantially coaxial relation, a portion of the spindle 60 which extends through the spindle aperture 92 into the inner housing chamber 93 (as best seen in FIGS. 5 and 10).

As best seen in FIG. 5, the outer housing surface 84 also defines two shoulders 86, 86 and a substantially continuous peripheral channel 88 of “U” shaped cross-section that extends from substantially adjacent to each shoulder 86 and is substantially transverse to the spindle axis “B”.

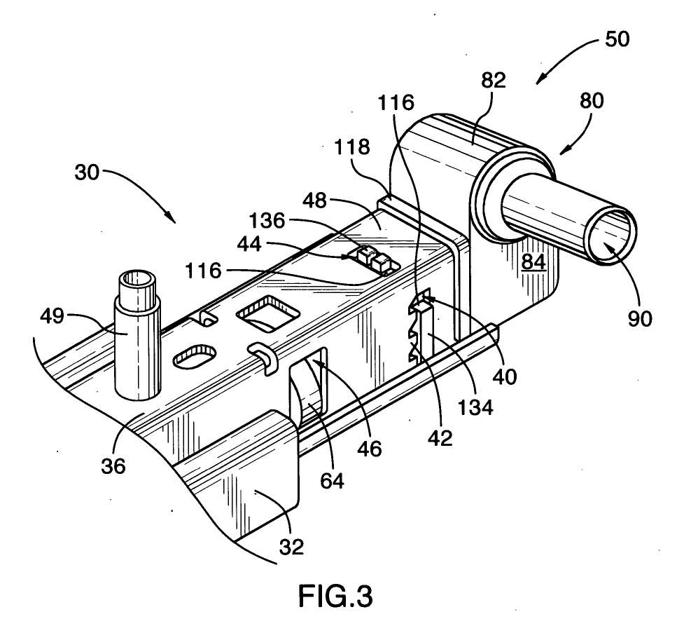

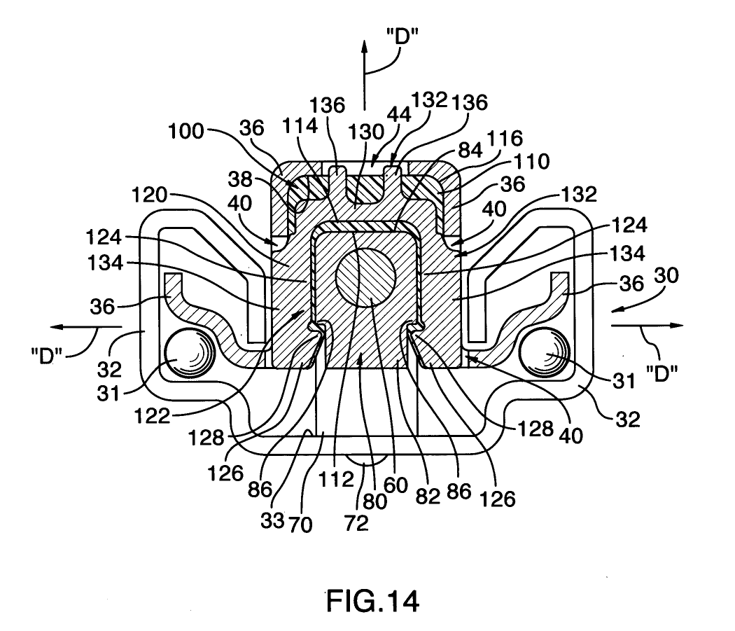

As best seen in FIGS. 5 and 11 to 13, the horizontal drive apparatus 50 includes a mounting means 100 for securing the transmission housing 82 to an end portion 48 of the movable track member 36 (as best seen in FIG. 3), with the mounting means 100 securely interposed therebetween (as best seen in FIG. 14). The mounting means 100 includes a damping means 110 for attenuating any noise and vibration emanating from the transmission means 80 during use, and for reducing noise vibration harshness. Preferably, the damping means 110 is a resilient member or rubberized jacket, and in a preferred embodiment, it may be formed of butadiene acrylonitrile rubber (also known as nitrile-butadiene rubber or NBR) or some other material that is resilient, resistant to tearing, and at least durable enough to withstand forces exerted upon the damping means 110 as a result of maximum forward and rearward extension of the vehicle seat slide 30.

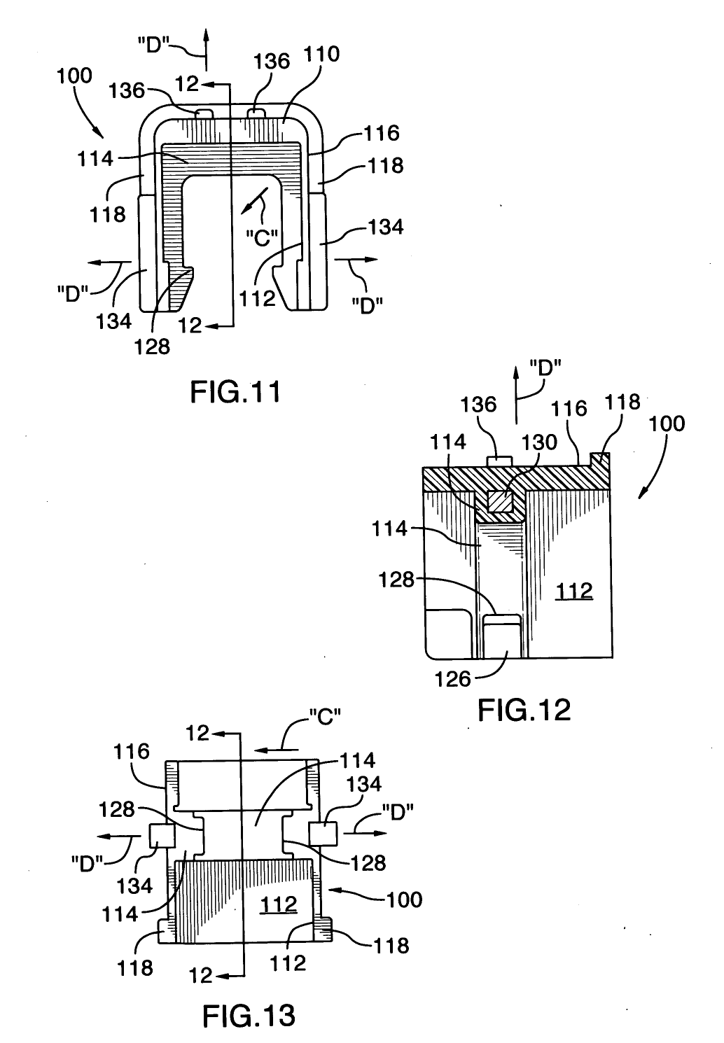

As best seen in FIG. 5, the damping means 110 has an inner jacket surface 112 and an outer jacket surface 116, with a foot portion 118 of the damping means 110 extending in an outward direction (indicated generally by arrow “D” in FIGS. 12 and 13) from the outer jacket surface 116. The damping means 110 also includes a “U”-shaped waist portion 114 that extends from the inner jacket surface 112 in a substantially inward direction (as indicated generally by arrow “C” in FIGS. 11 and 13).

As best seen in FIG. 14, the mounting means 100 also includes a retention clip member 120 having a transmission retaining portion 122. Preferably, the transmission retaining portion 122 is a spring clip having terminal lug portions 126, and is formed as a “U”-shaped saddle member having opposed arms 124, 124 and a connecting cross-member 130. Each of the terminal lug portions 126 extends in the inward direction “C” from a respective one of the arms 124, 124 and includes a catch member 128.

As will be best appreciated from FIGS. 7 and 11 to 14, the transmission retaining portion 122 is substantially encased within the damping means 110 between the outer jacket surface 116 and the inner jacket surface 112, with the cross-member 130 and the arms 124, 124 thereof being substantially integrated within the waist portion 114 (as best seen in FIGS. 12 and 14).

As best seen in FIGS. 3, 11, 12 and 14, the retention clip member 120 also has a track retaining portion 132 which includes two track retaining lug members 136, 136 and two ear members 134, 134, all of which extend through the outer jacket surface 116 of the damping means 110. The track retaining lug members 136, 136 extend in the outward direction “D” from the cross-member 130. Similarly, each one of the ear members 134, 134 extends in the outward direction “D” from a respective one of the arms 124, 124.

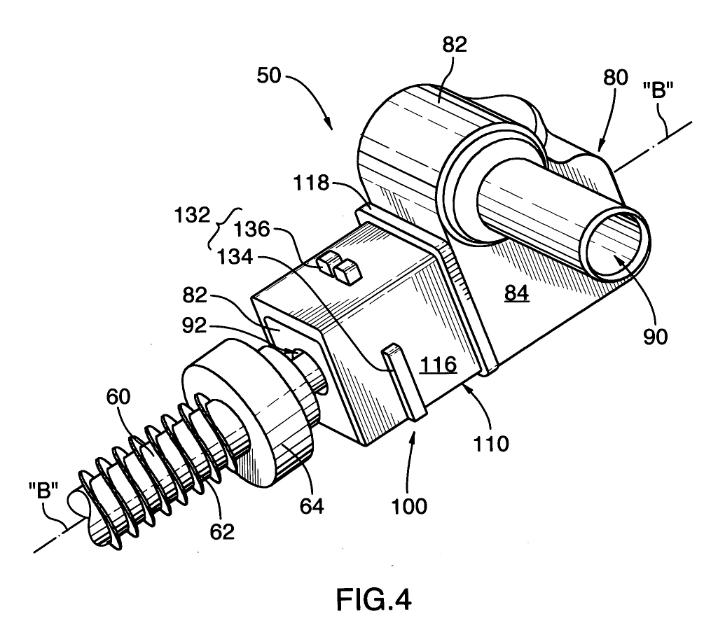

During assembly of the horizontal drive apparatus 50, the mounting means 100 is moved in a housing direction (as indicated generally by arrow “E” in FIG. 5) to partially surround the outer housing surface 84 of the transmission housing 82, with the waist portion 114 of the damping means 110 interfitting within the channel 88. The mounting means 100 is pressed in the housing direction “E” until each of the catch members 128, 128 compressibly secures the inner jacket surface 112 to a respective one of the shoulders 86, 86 of transmission housing 82. When the horizontal drive apparatus 50 is assembled as shown in FIGS. 4, 6 and 7, the inner jacket surface 112 overlies and engages the outer housing surface 84 in compressible secured surrounding relation (as best seen in FIG. 14), with the waist portion 114 of the damping means 110 received within the channel 88 formed in the outer housing surface 84 (as will be best appreciated from FIGS. 5, 12 and 13). As best seen in FIG. 14, the transmission retaining portion 122 is situated within the waist portion 114 and substantially straddles the outer housing surface 84, so as to substantially restrain longitudinal sliding movement of the retention clip member 120 relative to the transmission housing 82. In this manner, the mounting means 100 may be quickly, easily, and efficiently mounted to the transmission housing 82, such as to assemble the horizontal drive apparatus 50, without the transmission retaining portion 122 directly contacting the outer housing surface 84.

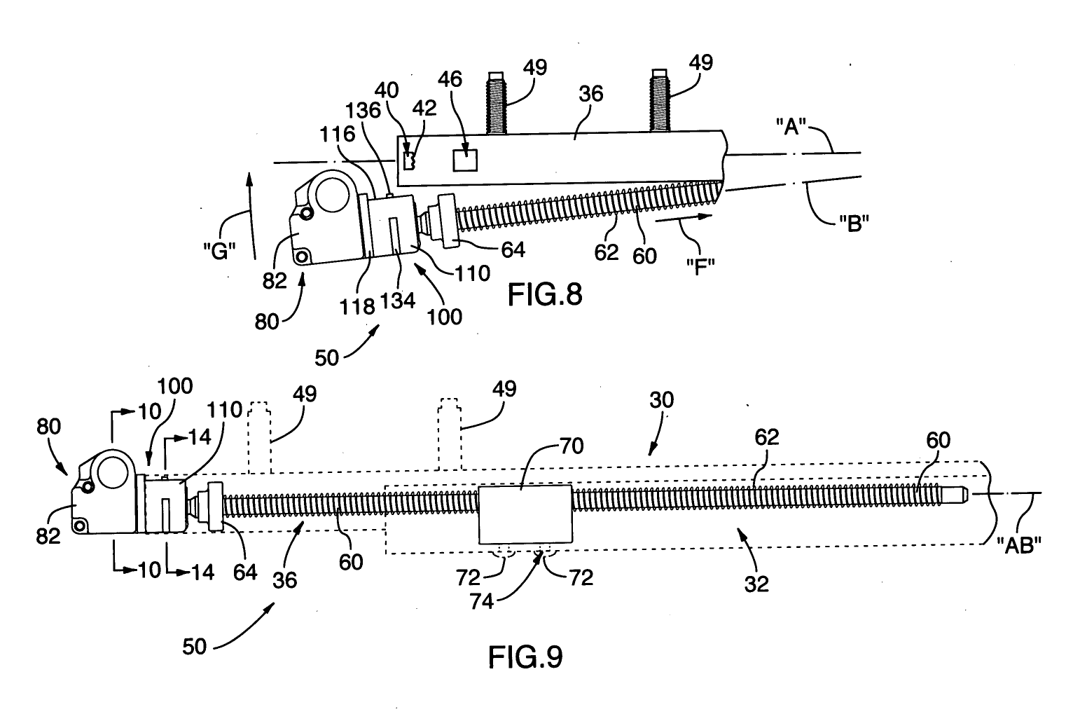

As best seen in FIG. 8, with the vehicle seat slide 30 in the forward configuration, the spindle 60 of the horizontal drive apparatus 50 is moved, during assembly, in a first track direction (as generally indicated by arrow “F”) into the movable track member 36. The spindle 60 of the horizontal drive apparatus 50 is inserted in the first track direction “F” into the movable track member 36 until, as best seen in FIG. 8, the ear members 134, 134 are substantially aligned with respective track ear apertures 40, 40 that are defined one each by opposing side portions of the movable track member 36.

The mounting means 100 of the horizontal drive apparatus 50 may then be easily moved in a second track direction (as generally indicated by arrow “G” in FIG. 8) into the movable track member 36, with the aid of a hydraulic press or otherwise, such that the outer jacket surface 116 of the damping means 110 underlies and engages the inner track surface 38 in compressible secured relation (as best seen in FIG. 14). In the preferred embodiment, the outer jacket surface 116 of the resilient member or damping means 110 is over-sized with respect to the inner track surface 38, and during this second assembly step, it is compressed within the movable track member 36 so as to be securely held in tight-fitting relation therewithin. After this second assembly step, and as best seen in FIG. 3, the foot portion 118 of the damping means 110 is substantially interposed, in abutting relation, between the transmission housing 82 and the end portion 48 of the movable track member 36. The mounting means 100 of the horizontal drive apparatus 50 is substantially self-seating and self-adjusting to compensate for tolerancing of the transmission housing 82 and the movable track member 36.

When the horizontal drive apparatus 50 is mounted to the seat slide 30 as aforesaid, and as best seen in FIGS. 3 and 14, the track retaining lug members 136, 136 preferably extend part-way through a track lug aperture 44 that is defined by a top portion of the movable track member 36, with the track retaining lug members 136, 136 preferably being removed from contact with the movable track member 36 (other than in the event of a vehicle crash, as will be described in further detail hereinbelow) Likewise, the ear members 134, 134 extend through the respective track ear apertures 40, 40. Additionally, the spindle 60 is provided with a spindle wheel 64 (as best seen in FIGS. 4 to 9) extending, when the horizontal drive apparatus 50 is mounted to the seat slide 30 as aforesaid, through a spindle wheel aperture 46 that is defined by the movable track member 36 (as best seen in FIG. 3).

As shown in FIG. 7, the spindle nut 70 preferably defines fastening apertures 74, 74 in a bottom surface thereof. When the horizontal drive apparatus 50 is mounted to the seat slide 30 as aforesaid, mating fasteners 72 are inserted into the fastening apertures 74 (as best seen in FIG. 9), so as to securely mount the spindle nut 70 to an inner fixed track surface 33 of the fixed track member 32.

In the manner described hereinabove, the horizontal drive apparatus 50 may be quickly, easily and efficiently mounted to the vehicle seat slide 30 as shown in FIGS. 1 to 3, 9 and 14, with the transmission housing 82 mounted substantially adjacent to the end portion 48 of the movable track member 36, without the need for dowel pins or similar fastening means requiring close fitting operative tolerances. As best seen in FIG. 9, the spindle axis “B” is then in substantially coaxial relation with the longitudinal axis “A” of the seat slide 30, and together they define a slide/spindle axis “AB”.

As shown in FIG. 1, each horizontal drive apparatus 50 is preferably operatively connected to an electrical drive motor 52 by means of a respective tubular drive cable housing 54 that extends therebetween. Each tubular drive cable housing 54 operatively encloses a flexible prior art drive cable having a hex nut end portion (not shown). The hex nut end portion extends through the drive aperture 90 of the transmission housing 82 and is drivingly secured within the hex nut sleeve coupling 98 of the pinion member 94 (best seen in FIG. 10).

In use of the horizontal drive apparatuses 50, 50 during fore-aft adjustment of the vehicle seat 20, a rotational driving force is transmitted from the electrical drive motor 52, through the drive cables situated within the cable housings 54, 54, so as to selectively rotate the pinion members 94, 94 in the inner housing chambers 93, 93. The pinion members 94, 94 are driven in unison by simultaneous and coextensive rotation of the drive cables which may spin at speeds as high as 3,000 rotations per minute. Thus, selectively driven rotation of the pinion members 94, 94 by activation of the drive motor 52 is coincident with rotation of the worm wheels 99, 99 and the spindles 60, 60 of the horizontal drive apparatuses 50, 50. Rotation of each spindle 60 about its spindle axis “B” causes translation of the spindle nut 70 along the spindle thread portion 62 thereof, and coincident movement of the corresponding vehicle seat slide 30 and seat assembly 20 between the forward and rearward configurations. As shown in FIG. 14, a plurality of ball bearings 31 are situated between the movable and fixed track members, 36 and 32 respectively, so as to facilitate their sliding engagement with each other. In this manner, movement of the vehicle seat assembly 20 between the forward and rearward configurations is driven by the horizontal drive apparatuses 50, 50.

Each horizontal drive apparatus 50 is mounted to its vehicle seat slide 30 such that, during movement of the vehicle seat slide 30 and vehicle seat assembly 20 between the forward and rearward configurations, the damping means 110 interposably engages, in the aforesaid compressibly secured relation, both the transmission housing 82 and the movable track member 36. The mounting means 100 removes the transmission housing 82 from direct contacting relation with, and restrains its longitudinal sliding movement relative to, the movable track member 36. As aforesaid, the damping means 110, because of its resilient rubberized construction, attenuates vibration and noise passing from the transmission means 80 into the movable track member 36 and the surrounding environment.

Each one of the track ear apertures 40, 40 preferably defines a plurality of teeth members 42 (best seen in FIG. 3). In a vehicle crash event, such as, for example, in the event of a rear impact to the vehicle, each respective one of the ear members 134, 134 is adapted to be deformingly engaged by the teeth members 42 of the track ear aperture 40, and to substantially restrain longitudinal sliding and upward lifting movement of the movable track member 36 relative to the horizontal drive apparatus 50. In such event, the teeth members 42 of the movable track member 36 dig in to the ear members 134, and provide an increased surface area of contact between the two components and an increased resistance to forces that may otherwise act to decouple the movable track member 36 from the mounting means 100. Likewise, the track retaining lug members 136, 136 are adapted to be deformingly engaged by the track lug aperture 44 and to take any excess loading which may be exerted upon the retention clip member 120 during the vehicle crash event. The spindle wheel 64 is also adapted to be deformingly engaged by the spindle wheel aperture 46 of the movable track member 36. In this manner, the mounting means 100 may be designed to easily withstand an impact equivalent to a 5,000 N vehicle crash event or greater without significant damage being sustained (i.e., sufficient to require repair or replacement), with the retention clip member 120 still operatively engaging the movable track member 36 so as to substantially maintain it in place relative to the transmission housing 82.

Other modifications and alterations may be used in the design and manufacture of other embodiments according to the present invention without departing from the spirit and scope of the invention, which is limited only by the accompanying claims. For example, the longitudinal axis “A” of the vehicle seat slide 30 need not necessarily be substantially horizontal, but could instead be merely somewhat horizontal, or it might even be substantially vertical. Likewise, the transmission means 80 need not necessarily include the pinion member 94 and the toothed worm wheel 99, but might instead comprise an alternate gear arrangement. Also, the mounting means 100 of the horizontal drive apparatus 50 might instead be mounted to the fixed track member 32, with the spindle nut 70 being affixed to the movable track member 36. Similarly, the damping means 110 need not necessarily engage the outer housing surface 84 in compressibly secured surrounding relation, but might merely engage same in compressibly secured relation. Likewise, the transmission retaining portion 122 of the retention clip member 120 need not be substantially encased within the damping means 110. Further, the transmission retaining portion 122 of the retention clip member 120 might be formed as a releasable clamp instead of as a spring clip, or indeed as any other structure capable of retaining the transmission means 80. Additionally, the mounting means 100 might be assembled with the vehicle seat slide 30 before it is mounted to the transmission housing 82. Given the various alternate embodiments of the horizontal drive apparatus 50 according to the present invention, of which the preceding named embodiments are merely examples, it is perhaps worthwhile to once again note that the invention is limited only by the accompanying claims.

1. A horizontal drive apparatus for use with a vehicle seat slide defining a longitudinal axis, said vehicle seat slide having mating fixed and movable track members, said movable track member slidably engaging said mating fixed track member for movement of said vehicle seat slide along said longitudinal axis between a forward configuration and a rearward configuration, with said fixed and movable track members being securely mountable to a vehicle cabin floor and to a vehicle seat cushion member respectively, said horizontal drive apparatus comprising:
a) an elongate spindle defining a spindle axis substantially parallel to said longitudinal axis, said spindle having a longitudinally extending spindle thread portion;
b) a spindle nut securely mountable to a first one of said track members, said spindle nut having an internal thread portion threadingly engagable with said spindle thread portion;
c) a transmission means, mountable to a respective other one of said track members, for selectively rotating said spindle about said spindle axis; and
d) a mounting means for securing said transmission means to said other one of said track members with the mounting means securely interposed therebetween, said mounting means including a damping means for attenuating noise and vibration emanating from said transmission means during use.

2. A horizontal drive apparatus according to claim 1, wherein said damping means comprises at least one resilient member adapted to engage, in compressible secured relation, at least one of said transmission means and said other one of said track members, such that said transmission means is removed from contacting relation with said other one of said track members.

3. A horizontal drive apparatus according to claim 2, wherein said transmission means comprises a transmission housing, and wherein said resilient member is adapted to engage at least one outer housing surface of said transmission housing in said compressible secured relation.

4. A horizontal drive apparatus according to claim 3, wherein said resilient member comprises a rubberized jacket having an inner jacket surface adapted to overlie and engage said outer housing surface in compressible secured surrounding relation.

5. A horizontal drive apparatus according to claim 4, wherein said mounting means further comprises a retention clip member having a transmission retaining portion adapted to secure said inner jacket surface to said outer housing surface in said compressible secured surrounding relation without itself contacting said outer housing surface.

6. A horizontal drive apparatus according to claim 5, wherein said retention clip member has a track retaining portion securely engagable with said other one of said track members to substantially restrain longitudinal sliding movement of said other one of said track members relative to said retention clip member and to said transmission housing.

7. A horizontal drive apparatus according to claim 6, wherein said transmission retaining portion is a spring clip having terminal lug portions adapted to secure said inner jacket surface to said outer housing surface in said compressible secured relation.

8. A horizontal drive apparatus according to claim 7, wherein said jacket has an outer jacket surface adapted to underlie and engage at least one inner track surface of said other one of said track members in said compressible secured relation.

9. A horizontal drive apparatus according to claim 8, wherein said spring clip is formed as a “U”-shaped saddle member having opposed arms and a connecting cross-member, with each of said terminal lug portions extending in a substantially inward direction from a respective one of said arms.

10. A horizontal drive apparatus according to claim 9, wherein said outer housing surface is shaped to define two shoulders, and wherein each of said terminal lug portions comprises a catch member adapted to secure said inner jacket surface to a respective one of said shoulders in said compressible secured relation.

11. A horizontal drive apparatus according to claim 10, wherein said spring clip of said retention clip member is substantially encased within said jacket between said outer jacket surface and said inner jacket surface.

12. A horizontal drive apparatus according to claim 11, wherein said track retaining portion of said retention clip member comprises at least one ear member extending from said spring clip in a substantially outward direction, and with each said ear member being extendable at least partially through a track ear aperture defined by said other one of said track members so as to restrainingly engage said other one of said track members.

13. A horizontal drive apparatus according to claim 12, wherein each said ear member extends through said outer jacket surface.

14. A horizontal drive apparatus according to claim 13, wherein said at least one ear member comprises two ear members adapted to extend one each in said outward direction from a respective one of said arms, with each of said ear members being fully extendable through a respective one said track ear aperture.

15. A horizontal drive apparatus according to claim 14, wherein said outer housing surface is shaped to define a substantially continuous peripheral channel that is substantially adjacent to each said shoulder, wherein said inner jacket surface defines a substantially inwardly directed corresponding waist portion, and wherein said arms and said cross-member of said saddle member are substantially integrated within said waist portion of said inner jacket surface, with said waist portion being adapted to be received within said channel in close interfitting relation with said saddle member substantially straddling said outer housing surface, thereby to substantially restrain longitudinal sliding movement of said retention clip member relative to said transmission housing.

16. A horizontal drive apparatus according to claim 15, wherein said channel is substantially transverse to said spindle axis.

17. A horizontal drive apparatus according to claim 16, wherein at least a first one of said ear members and said track ear aperture is shaped to define at least one tooth member, with each said tooth member adapted to deformingly engage a respective other one of said ear members and said track ear aperture in a crash event.

18. A horizontal drive apparatus according to claim 17, wherein said at least one tooth member comprises a plurality of teeth members, wherein each said track ear aperture is shaped to define said teeth members, and wherein each of said teeth members is adapted to deformingly engage a respective one of said ear members in said crash event.

19. A horizontal drive apparatus according to claim 18, wherein said track retaining portion of said retention clip member further comprises at least one track retaining lug member extending in said outward direction from said spring clip, with each said track retaining lug member being extendable at least partially through a track lug aperture defined by said other one of said track members, and with each said track retaining lug member being adapted to deformingly engage said track lug aperture in said crash event.

20. A horizontal drive apparatus according to claim 19, wherein each said track retaining lug member extends through said outer jacket surface.

21. A horizontal drive apparatus according to claim 20, wherein said at least one track retaining lug member comprises two track retaining lug members extending in said outward direction from said cross-member.

22. A horizontal drive apparatus according to claim 21, wherein said first one of said track members is said fixed track member, and wherein said other one of said track members is said movable track member.

23. A horizontal drive apparatus according to claim 22, wherein said spindle nut is securely mountable to an inner fixed track surface of said fixed track member, and wherein said transmission means is mountable to an end portion of said movable track member.

24. A horizontal drive apparatus according to claim 23, wherein said transmission housing substantially encloses a selectively rotatable pinion member and a toothed worm wheel, said pinion member having a worm screw thread in rotatable meshing engagement with said toothed worm wheel, and with said toothed worm wheel securely engaging said spindle in substantially coaxial relation, such that said selective rotation of said pinion member is coincident with rotation of said worm wheel and said spindle.

25. A mounting apparatus for use with a vehicle seat slide track member and a transmission housing, said mounting apparatus comprising a resilient member adapted to interposably engage, in compressible secured relation, said transmission housing and said track member, such that said transmission housing is removed from contacting relation with said track member, and so as to attenuate noise and vibration emanating from said transmission housing during use.

26. A mounting apparatus according to claim 25, wherein said resilient member comprises a rubberized jacket having an inner jacket surface adapted to overlie and engage at least one outer housing surface of said transmission housing in compressible secured surrounding relation.

27. A mounting apparatus according to claim 26, wherein said mounting apparatus further comprises a retention clip member having a transmission retaining portion adapted to secure said inner jacket surface to said outer housing surface in said compressible secured surrounding relation without itself contacting said outer housing surface.

28. A mounting apparatus according to claim 27, wherein said retention clip member has a track retaining portion securely engagable with said track member to substantially restrain longitudinal sliding movement of said track member relative to said retention clip member and to said transmission housing.

29. A mounting apparatus according to claim 28, wherein said transmission retaining portion is a spring clip having terminal lug portions adapted to secure said inner jacket surface to said outer housing surface in said compressible secured relation.

30. A mounting apparatus according to claim 29, wherein said jacket has an outer jacket surface adapted to underlie and engage at least one inner track surface of said track member in said compressible secured relation.

31. A mounting apparatus according to claim 30, wherein said spring clip is formed as a “U”-shaped saddle member having opposed arms and a connecting cross-member, with each of said terminal lug portions extending in a substantially inward direction from a respective one of said arms.

32. A mounting apparatus according to claim 31, wherein said spring clip of said retention clip member is substantially encased within said jacket between said outer jacket surface and said inner jacket surface.

33. A mounting apparatus according to claim 32, wherein said track retaining portion of said retention clip member comprises two ear members extending from said spring clip in a substantially outward direction, with each of said ear members being extendable at least partially through a respective track ear aperture defined by said track member so as to restrainingly engage said track member.

34. A mounting apparatus according to claim 33, wherein each of said ear members extends through said outer jacket surface.

35. A mounting apparatus according to claim 34, wherein said inner jacket surface defines a substantially inwardly directed corresponding waist portion, and wherein said arms and said cross-member of said saddle member are substantially integrated within said waist portion of said inner jacket surface, with said waist portion being adapted to be received within a corresponding channel defined by said outer housing surface in close interfitting relation with said saddle member substantially straddling said outer housing surface, thereby to substantially restrain longitudinal sliding movement of said retention clip member relative to said transmission housing.

36. A mounting apparatus according to claim 35, wherein said track retaining portion of said retention clip member further comprises two track retaining lug members extending in said outward direction from said cross-member of said spring clip, with each of said track retaining lug members being extendable at least partially through a track lug aperture defined by said track member, and with each said track retaining lug member being adapted to deformingly engage said track lug aperture in a crash event.

37. A mounting apparatus according to claim 36, wherein each said track retaining lug member extends through said outer jacket surface.
